(19) United States
(12) Patent Application Publication
(10) Pub. No.: US 2024/0073995 A1
(43) Pub. Date: Feb. 29, 2024

(54) METHOD AND APPARATUS FOR MANAGING CONNECTION

(71) Applicant: SAMSUNG ELECTRONICS CO., LTD., Suwon-si (KR)

(72) Inventors: Himanshu SHARMA, Uttar Pradesh (IN); Sakshi BHATIA, Uttar Pradesh (IN); Dheerendra KUMAR, Uttar Pradesh (IN)

(21) Appl. No.: 18/084,941

(22) Filed: Dec. 20, 2022

(30) Foreign Application Priority Data
Aug. 23, 2022 (IN) 202241047883

(51) Int. Cl. H04W 76/38

(52) U.S. Cl. CPC H04W 76/38

(57) ABSTRACT

A method for managing a connection by a server is provided. The method may comprise monitoring a state of a Transmission Control Protocol (TCP) connection for a communication session of a receiver device by Internet Protocol Multimedia Subsystem (IMS) stack, based on a plurality of signal parameters and connection context information for a defined period in absence of packet communication; based on the state of the TCP connection for the communication session being suspended, closing the TCP connection; and based on the state of the TCP connection for the communication session being registered, selecting one or more Session Initiation Protocol (SIP) timers for resetting and routing the communication session of the receiver device.

### CROSS REFERENCE TO RELATED APPLICATIONS

This application is based on and claims priority under 35 U.S.C. § 119 to Indian Patent Application Serial No. 202241047883 (CS), filed on Aug. 23, 2022, in the Indian Patent Office, the disclosure of which is hereby incorporated by reference herein in its entireties.

### BACKGROUND

### Field

Certain example embodiments relate to a method for detecting lost Transmission Control Protocol (TCP) connection packets and/or recovering the old connection. For example, a method for managing no network and/or limited connectivity state for the communication session in the device by auto recovering an old connection thereby avoiding or reducing retransmission of the lost TCP packets.

### Description of Related Art

Transmission Control Protocol (TCP) is a connection-oriented, dependable, byte-based transport layer communication protocol that serves as the underlying protocol foundation for many widely known applications such as Hyper Text Transfer Protocol (HTTP), File Transfer Protocol (FTP), Secure Shell (SSH), and Simple Mail Transfer Protocol (SMTP), whereas some applications prefer User Datagram Protocol (UDP) for transmission to avoid delays, but this can result in packet loss, which can lead to call drops. The TCP protocol provides the necessary functionality for reliable communications, such as flow control, packet loss detection, lost packet retransmission, and congestion avoidance. TCP establishes a secure connection with a three-way handshake. Both sides synchronize (SYN) and acknowledge (ACK) each other on a full duplex connection.

TCP can detect if a packet goes missing and resend it, accordingly, ensuring reliable transmission of data. Retransmissions are required in the event of lost packets, which takes time, slows down applications and has a significant impact on application performance. However, one of the biggest challenges is determination of lost connection and avoidance of any packet loss retransmission which may lead to call drop and call fails.

Various attempts have been made for improving the reliability of the TCP connection. One solution is to modify the TCP implementation of one or both of the participants. However, this is frequently not a viable option, such as when the source code is unavailable or there are too many endpoints to manage conveniently.

For instance, US Patent Application No. U.S. Pat. No. 8,411,560B2 titled “TCP selection acknowledgements for communicating delivered and missing data packets” discloses a method for detection and retransmission of lost packets over a network, wherein a sorted list comprising an index of consecutive sets of continuous ranges of sequence numbers identifying data packets received by the receiver are maintained, generating identified selective acknowledgment (SACK) packet. A receiver or a proxy acting therefor receives the SACK packets and infers that a set of data packets between the consecutive ranges have not been received. Based on this, the sender retransmits data packets according to any of a number of schemes. However, “U.S. Pat. No. 8,411,560B2” merely discloses the method for detecting and retransmitting the lost packets over network and does not disclose details pertaining to auto recovery of the old TCP connection, and/or avoidance or reduction of packets loss retransmission.

For instance, US Patent Application No. US20060171318A1 titled “Active queue management methods and devices” discloses receiving an incoming packet, estimating an overall occupancy level 0 of an input buffer, determining a number N of active virtual output queues (“VOQs”) of the input buffer, computing a probability P based on the overall occupancy level and the number of VOQs, generating a random number R; and setting a flag when R is less than P. However, US20060171318A1 merely discloses the method to control overall buffer occupancy and protecting uncongested individual VOQS, and further to detect packet drop by computing the probability which is based on buffer occupancy, but does not disclose details pertaining to auto recovery of the old TCP connection, and/or avoidance or reduction of packets loss retransmission.

For instance, US Patent Application No. U.S. Pat. No. 7,969,876B2 titled “Method of determining path maximum transmission unit” discloses increasing a size of a path maximum transmission unit (PMTU) by a predetermined amount for transmitting network packets between a client and a server via the first proxy, repacketizing network packets received from the client for transmission to the server into packet sizes in accordance with the size of the PMTU, determining a first network packet of the repacketized network packets with a round trip time greater than a previous round trip time for networks packets transmitted to the server, and increasing the size of the PMTU by the predetermined amount responsive to receiving an acknowledgement for the first network packet without a fragmentation indication. However, U.S. Pat. No. 7,969,876B2 merely discloses the method to detect the maximum transmission unit of a path to avoid IP fragmentation, and does not disclose details pertaining to auto recovery of the old TCP connection, and/or avoidance or reduction of packets loss retransmission.

Hence, there exists a need for a method to detect a connection lost, for example to avoid and/or reduce any packet loss retransmissions, and/or to recover the lost TCP connection.

### SUMMARY

Certain example embodiments relate to a method for managing a connection by a server. The method may comprise monitoring a state of a Transmission Control Protocol (TCP) connection for a communication session of a receiver device by Internet Protocol Multimedia Subsystem (IMS) stack, based on a plurality of signal parameters and connection context information for a defined period in absence of packet communication. The method may comprise based on the state of the TCP connection for the communication session being suspended, closing the TCP connection. The method may comprise based on the state of the TCP connection for the communication session being registered, selecting one or more Session Initiation Protocol (SIP) timers for resetting and routing the communication session of the receiver device.

Certain example embodiments relate to a server for managing a connection by a server. The server may comprise communication circuitry and at least one processor coupled to the communication circuitry. The at least one processor may be configured to monitor a state of a Transmission Control Protocol (TCP) connection for a communication session of a receiver device by Internet Protocol Multimedia Subsystem (IMS) stack, based on a plurality of signal parameters and connection context information for a defined period in absence of packet communication. The at least one processor may be configured to based on the state of the TCP connection for the communication session being suspended, close the TCP connection. The at least one processor may be configured to based on the state of the TCP connection for the communication session being registered, select one or more Session Initiation Protocol (SIP) timers for resetting and routing the communication session of the receiver device

Certain example embodiments provide a method to detect lost TCP packets and automatically recover the old connection at least by resetting. Additionally, the method may also help in handling no network and/or limited connectivity state for the communication session thereby avoiding or reducing retransmission of lost packets. Certain example embodiments may offer less connectivity issues and customer satisfaction.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a flowchart of the method for detecting lost connection and auto recovering of old connection according to an example embodiment.

FIG. 2 illustrates an example embodiment of a method for transmitting, acknowledging data packets and detecting lost packets.

FIG. 3 illustrates a functional block diagram of the IMS stack according to an example embodiment.

FIG. 4 illustrates a functional block diagram of the network monitoring module according to an example embodiment.

FIG. 5 illustrates a functional block diagram of the TCP rectifying module according to an example embodiment.

FIG. 6 illustrates a snapshot of the first example configuration for auto recovery of the lost TCP connection according to an example embodiment.

FIG. 7 illustrates a snapshot of the second example configuration for auto recovery of the lost TCP connection according to an example embodiment.

FIG. 8 illustrates a snapshot of the third example configuration for auto recovery of the lost TCP connection according to an example embodiment.

### DETAILED DESCRIPTION

Reference will now be made in detail to the description of the present subject matter, one or more examples of which are shown in figures. Each example is provided to explain the subject matter and not a limitation. Various changes and modifications are deemed to be within the spirit, scope and contemplation herein.

In any network environment, data is sent and received across the network in small units called packets. The failure of packets to reach their destination on a network is referred to as packet loss. Packet loss is usually caused by network equipment dropping, ignoring, misdelivering, or discarding packets as a result of network congestion. Packet loss affects different applications in different ways. Delays can be exacerbated if the packet loss rate is high or there is high latency. If a packet is dropped, or not acknowledged, TCP connections can detect lost packets using a timeout, more particularly after sending off a packet, the sender starts a timer (of about 128 seconds) and places the packet in a retransmission queue, if the timer runs out and the sender has not yet received an ACK (acknowledgement) from the recipient, it sends the packet again leading to retransmission. Sometimes packet drop could go unnoticed by several network nodes, causing them to wait forever. Due to some nodes' potential for silent packet drops, all nodes could get out of sync and the device loses contact, necessitating for a new connection. The present disclosure provides a method for resetting the old TCP connection thereby avoiding retransmission of lost TCP packets.

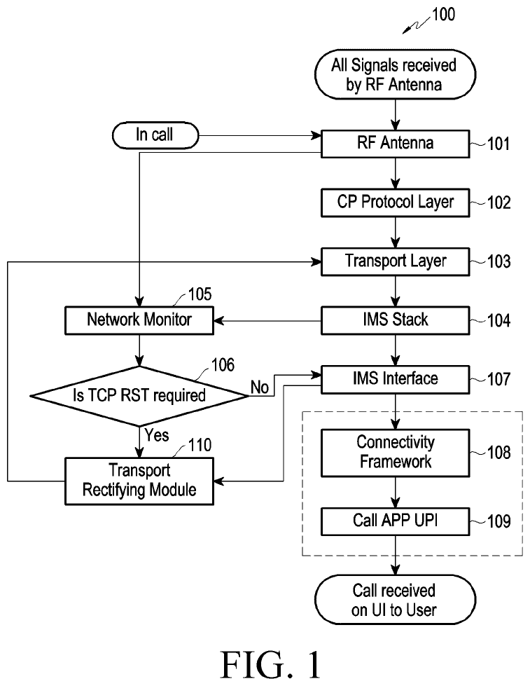

Referring now to FIG. 1, a flowchart of the method for detecting lost connection and auto recovering of old connection is illustrated, wherein the method (100) comprises the steps of receiving at least one signal indicative of the presence of an incoming and outgoing call by a Radio Frequency (RF) antenna installed on a receiver device and further establishing a Transmission Control Protocol (TCP) connection between a sender device and the receiver device in step (101), wherein in an example embodiment, the sender device and receiver device may be a smartphone device, a laptop, or a tablet.

In step (102), the TCP connection thus established between the sender and the receiver device is managed by a communication processor (CP) protocol layer. In an embodiment, the communication processor protocol layer follows Long Term Evolution (LTE) protocol for latching the receiver device to at least one of the communication networks. Subsequently, in step (103) a communication session between the receiver device and at least one communication network may be configured, wherein the communication session may be an IMS session between the receiver device and the sender device. In an example embodiment, the communication session between the receiver device and at least one communication network may be facilitated by a transport layer.

In an example embodiment, the transport layer protocols are typically in charge of point-to-point communication. In other words, the transport layer protocols manage, establish, and terminate communication between two specific networked devices. The transport layer essentially allows multiple networking applications that reside above the transport layer to establish client-server, point-to-point communication links to other devices via functionality such as flow control. Furthermore, the transport layer ensures that packets sent are received and assembled in the correct order acknowledging the transmitter after receiving an error-free packet and when a defective packet is received, the request for re-transmission to the transmitter is made.

In step (104), a handling ID for every user agent (209), is created and returned to a connectivity framework (203) by an IP Multimedia Subsystem (IMS) stack (211). In an example embodiment, the communication Session Initiation Protocol (SIP) may be routed and managed by the user agent (209), wherein the communication SIP may be responsible for the signaling operations of the communication session. Furthermore, the IMS stack (211) is responsible for receiving IMS registration information of the receiver device and registering the receiver device in an IMS server by using at least some of the received IMS registration information of the receiver device. Each server herein, and each receiver device herein, comprises a processor comprising processing circuitry. Each of the steps/operations herein may be performed by at least one processor, and communications herein may be utilized in conjunction with communication circuitry. Moreover, each “module” herein may comprise circuitry.

In step (105), of the method, a plurality of signal properties, and the connection context information are monitored by a network monitoring module (202) required for monitoring the health of the TCP connection. In an embodiment, the plurality of signal properties may include strength and position of the signal received by the RF antenna of the receiver device and a Reference Signal Received Power (RSRP), a Reference Signal Received Quality (RSRQ), a Received Signal Strength Indicator (RSSI), a Signal to Interference Noise Ratio (SINR), and a Channel Quality Indicator (CQI). In an embodiment, the connection context information may include the time spent by the receiver device at low strength signal and it may further include within the same time span, the TCP connection is released and a cell ID for a defined period of time. Furthermore, a request for monitoring the health of the TCP connection, the plurality of signal properties and the connection context information may be received from an IP Multimedia Subsystem (IMS) stack (211).

In step (106) of the method (100), a check may be performed to determine whether TCP connection resetting is required or not. If at step (106), it is determined that the TCP connection resetting is not required, the method (100) may proceed to the step (107) “No path”, where all the modules interact with the IMS stack (211) through the IMS interface layer and further the method (100) continues towards step (108) which redirects the call to the IMS interface (204) or the CP protocol layer depending on the type of underlying physical transport.

In step (109), of the method (100) the call may be redirected to the call application on the receiver's device user interface. In an embodiment, the calling application user interface allows users to receive or place audio or video calls or data calls on their device. Calling applications use their own user interface for the calls instead of using the default device application interface. However, if at step (106), it is determined that the TCP connection resetting is required, the method (100) may proceed to step (110) (“Yes” path). At step (110), the request to delete the stale TCP connections may be redirected towards the transport rectifying module (314). In an embodiment, a request to delete the stale TCP connection may be received by the transport rectifying module (314) from the IMS interface (204), and further, the method (100) may continue to repeat the steps (107)-(109), wherein IMS services may resume without any retransmission by selectively choosing one or more Session Initiation Protocol (SIP) timers via TCP port.

Meanwhile, the above-described method (100) performed by the electronic device may be performed using an artificial intelligence model. According to the disclosure, in a method (100) for packet loss detection with automatic recovery while maintaining a physical connection of an electronic device (such as mobile, or tablet) with the network operator, a method for recognizing a user's speech and interpreting the user's intent, the device may receive a speech signal, which is an analog signal, via a microphone and convert the speech part into computer readable text using an automatic speech recognition (ASR) model. The user's intent of utterance may be obtained by interpreting the converted text using a natural language understanding (NLU) model. The ASR model or NLU model may be an artificial intelligence model. The artificial intelligence model may be processed by an artificial intelligence-dedicated processor designed in a hardware structure specified for artificial intelligence model processing. The artificial intelligence model may be obtained by training. Here, “obtained by training” may indicate that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

Language understanding is a technique for recognizing and applying/processing human language/text and includes, e.g., natural language processing, machine translation, dialog system, question answering, or speech recognition/synthesis.

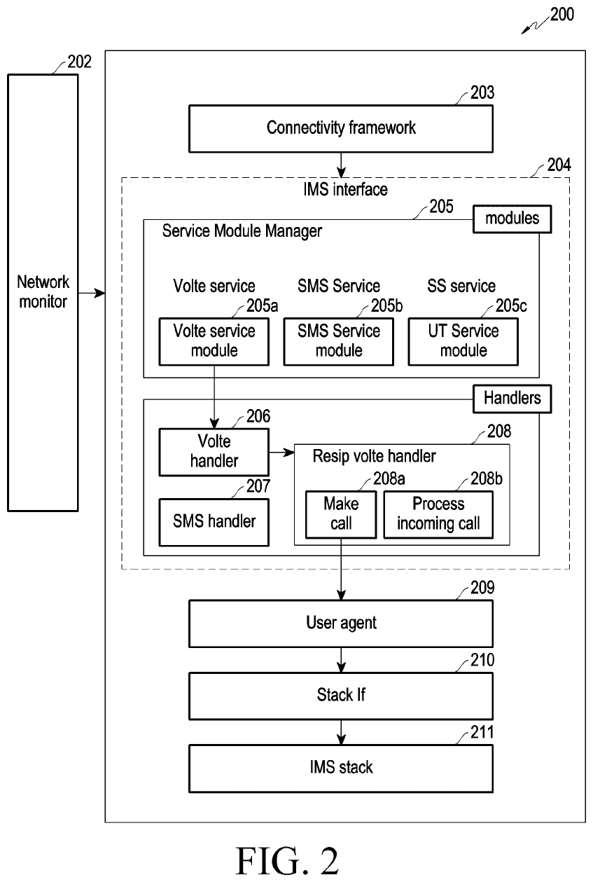

Referring now to FIG. 2, an example embodiment of a method for transmitting, acknowledging data packets and detecting lost packets (200) is illustrated. The IMS interface (204) may be configured to receive the notification related to the monitored health of the TCP connection, the plurality of signal properties, and the connection context information by the network monitoring module (202). Further, the IMS interface (204) may be configured to verify the monitored health of the TCP connection based on the plurality of signal properties, and the connection context information for the purpose of resetting the old TCP connection.

In order to perform the above functions, in an example embodiments, the IMS interface (204) may include various components, for example, service module manager (205) with subcomponents namely VoLTE service component (205a), SMS service component (205b) and UT service component (205c). And the other components of the IMS interface (204) may include VoLTE handler (206), SMS handler (207), and ReSIP VoLTE handler (208). In an embodiment, the ReSIP VoLTE handler (208) may be responsible for making a call (208a) and processing a call (208b).

Various components of the IMS interface (204) may provide a standard-based networking architecture for multimedia services provided on the user device. The service module manager (205) may provide a single point of access for communication using an IMS registration, with the user agent (209) for handling Session Initiation Protocol (SIP) messaging and more particularly directs, routes messages and request to the IMS stack (211). The SIP is used by the IMS to establish and control calls or sessions between user terminals (or user terminals and application servers). SIP employs a network proxy server infrastructure to locate other users, to which users can send registrations, invitations to sessions, and other requests via their terminals.

In an embodiment, the service module manger (205) of the IMS interface (204) may be configured to receive the notification regarding the monitored health of the TCP connection based on the plurality of signal properties, and the connection context information by the network monitoring module (202). The service module manager (205) may further be configured to redirect the state of the monitored variables to the VoLTE handler (206). The VoLTE handler (206) further redirects the monitored value to the ReSIP VoLTE handler (208). The ReSIP VoLTE handler (208) may be configured to handle IMS session during the call. As will be appreciated by those skilled in the art, all the changes during the duration of the call are responsible for deleting the TCP connection after the network monitoring module (202) notifies the monitored state of the variables to the IMS interface (204). In an embodiment, Stack IF (210) acts as an interface between the IMS Interface (204) and the IMS Stack (211).

In an embodiment, IMS registration generally involves the exchange of SIP messages to control communication sessions supporting voice, data and video calls over IP, LTE, and other data networks. SIP may be used for establishing, modifying, and terminating communications sessions and the sessions may be used for a plurality of media streams that support certain applications including VoIP, UT, and SMS, etc.

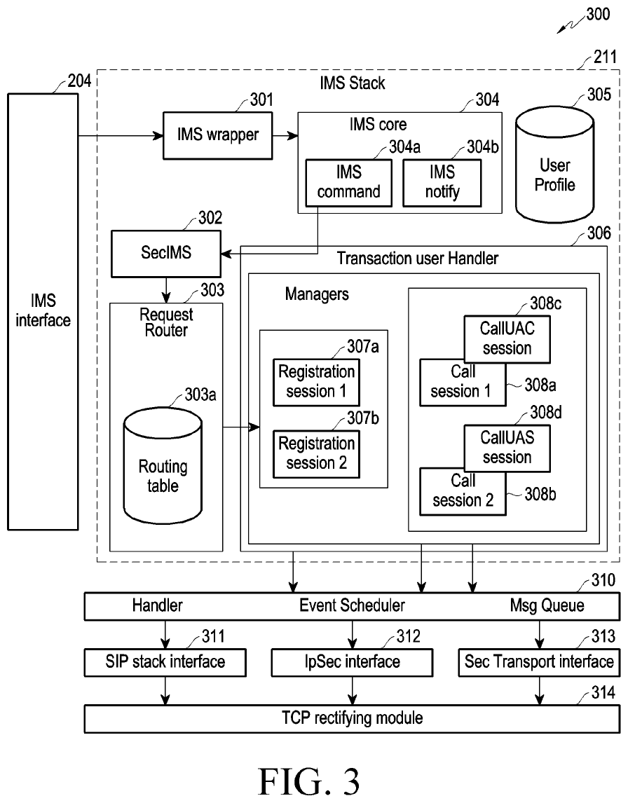

Referring now to FIG. 3, a functional block diagram of the IMS stack (300) is illustrated. IMS Stack (211) may be configured to create a handle ID for each user agent (209) and returns the handle ID to the connectivity framework (203). Further, the connectivity framework (203) communicates with an IMS core via this handle ID for additional request and response such as registration, call and so on.

In order to perform the above functions, in an example embodiments, the IMS stack (211) may include various components, for example, a JAVA Native Interface (JNI) wrapper (301), a Security IMS (SecIMS) (302), a request router (303), a routing table (303a), the IMS core (304) with an IMS command (304a), an IMS notify (304b), a user profile (305), a transaction user handler (306), a registration session land 2 (307a, 307b), and a call session 1 and 2 (308a, 308b).

An IMS command (304a) comprising a request to delete the stale TCP connection is dispatched from the IMS Interface (204) to the request router (303). In an embodiment, the IMS command (304a) may be written using any programming language and may be directed towards the JNI wrapper (301) which allows Java applications to interoperate with native applications and libraries written in different programming languages. In other words, the JNI wrapper (301) provides access to software programs associated with the transceiver that are written in a language other than Java. The interpolated IMS command (304a) may then be redirected towards the request router (303) after passing through the (SecIMS) (302) to enable security. The request router (303) allows to route a SIP request directly to the server.

In an embodiment, the request router (303) examines destination IP address of a received packet and makes routing decisions accordingly. The request routers (303) use routing tables (303a) to determine which interface the packet will be sent and further sends the packet to the registration manager of the directed IP address of a particular registration session such as registration session 1,2 (307a, 307b). Registration manager manages the registration session and thereafter, the session sends the request to delete TCP connection to a security transport interface (313) which further transmits the requests to the TCP rectifying module (314) to delete the TCP connection, wherein the security transport interface (313) acts as an interface between IMS Stack (211) and TCP rectifying module (314).

In an embodiment, the routing table (303a) contains the information necessary to forward a packet along the best path toward its destination for e.g., the routing table lists all networks for which routes are known. Each packet contains information about its origin and destination. The routing table (303a) provides the device with instructions for sending the packet to the next hop on its route across the network. Each router's routing table (303a) is unique and stored in the RAM of the device.

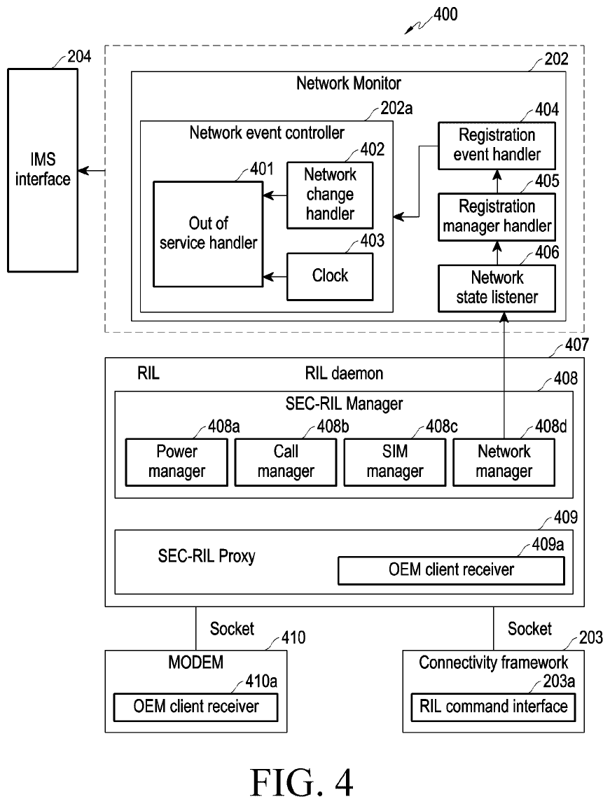

Referring now to FIG. 4, a functional block diagram of the network monitoring module (400) is illustrated, in accordance with an example embodiment. The network monitoring module (202) may be configured to monitor plurality of signal properties and connection context information in order to track the health of the TCP connection. The network monitoring module (202) may comprise of a network event controller (202a) which further comprises an out of service handler (401), a network change handler (402) and a clock (403).

In an embodiment, the connectivity framework (203) has an interface which keeps track of each incoming/outgoing request that has been sent/receive to a Radio Interface Layer (RIL) (407). More particularly the connectivity framework (203) forms socket connection with the RIL (407). The radio interface layer acts as a bridge between the connectivity framework (203) services and the hardware such as a modem (410). In other words, it is the protocol stack for the device such as smartphone, tablet, laptop and so on. In an embodiment the receiver device may be a wireless communication device and includes modem (410), which can also be referred to as a transceiver. In an example embodiments, the sending and receiving of communication signals occur wirelessly and are facilitated by one or more RF antennas coupled to the modem (410).

In an embodiment, the RIL (407) comprises of two components namely, RIL daemon and vendor RIL. The RIL daemon links the connectivity framework (203) to the vendor RIL. When the device process starts and the connectivity framework (203) is initialized, the connectivity framework (203) makes socket connection to RIL daemon, and the RIL daemon finds the path of vendor RIL library from system properties and loads vendor RIL in form of so found library.

In an embodiment, two types of commands are used in RIL (407) interaction commands and events. The commands are originated by the application framework and include their responses. The events are indications originating from the hardware device such as modem (410). For example, the indication of incoming call is received as an event. In another embodiment, the modem tracks the values of RSRP, RSRQ, RSSI, SINR and CQI from the sensor and notifies the values to the RIL (407) and thereafter the RIL (407) notifies same to the network monitoring module (202).

In an embodiment, the network monitoring module (202) further comprises a network state listener (406), a registration manger handler (405), and a registration event handler (404). The network state listener (406) defines the changes in the state of the network and returns a true value if there is a connection, and otherwise returns a false value. Further, the registration manager handler (405) is a handler that registers observers and acts as receivers for the event. After receiving the network event corresponding to the response received from the network state listener (406), the registration manager handler (405) sends the event of network type change to the registration events handler (404) and further, based on the network type change event, the registration event handler (404) processes and starts the network event controller (202a). Furthermore, the network event controller (202a), along with its subcomponents notifies the health of the TCP connection to the IMS interface (204).

In an embodiment, Reference Signal Received Power (RSRP) and Reference Signal Received Quality (RSRQ) are key measures of signal level and quality for modern LTE networks. In cellular networks, when a mobile moves from cell to cell and performs cell selection/reselection and handover, it has to measure the signal strength/quality of the neighbor cells. In an LTE network, a user device measures two parameters on reference signal: and RSRQ, wherein RSRP is the power of the LTE Reference Signals spread over the full bandwidth and narrowband and RSRQ is a C/I type of measurement, and it indicates the quality of the received reference signal. The RSRQ measurement provides additional information when RSRP is not sufficient to make a reliable handover or cell reselection decision.

In an embodiment, Received Signal Strength Indicator (RSSI) is an estimated measurement of how well a device can hear, detect and receive signals from any wireless access point or Wi-Fi router. In other words, RSSI is an indication of the power level being received by the receiving radio after the antenna and possible cable loss. In an embodiment, Signal to Interference Noise Ratio (SINR) also known as the signal-to-noise-plus-interference ratio (SNIR) is a quantity used to give theoretical upper bounds on channel capacity (or the rate of information transfer) in wireless communication systems such as networks. SINR is widely used in wireless communication to assess the quality of wireless connections. In wireless networks, the energy of a signal typically fades with distance, which is referred to as path loss. In wired networks, the presence of a wired path between the sender or transmitter and the receiver determines data reception. In an embodiment, expressed as a data rate that terminal User Equipment (UE) can support under the actual radio conditions. In an embodiment, the channel quality information (CQI) is a 4-bit value that indicates the highest modulation and code rate for a received transport block that meets a block error rate target of at most 10% (as estimated by the UE).

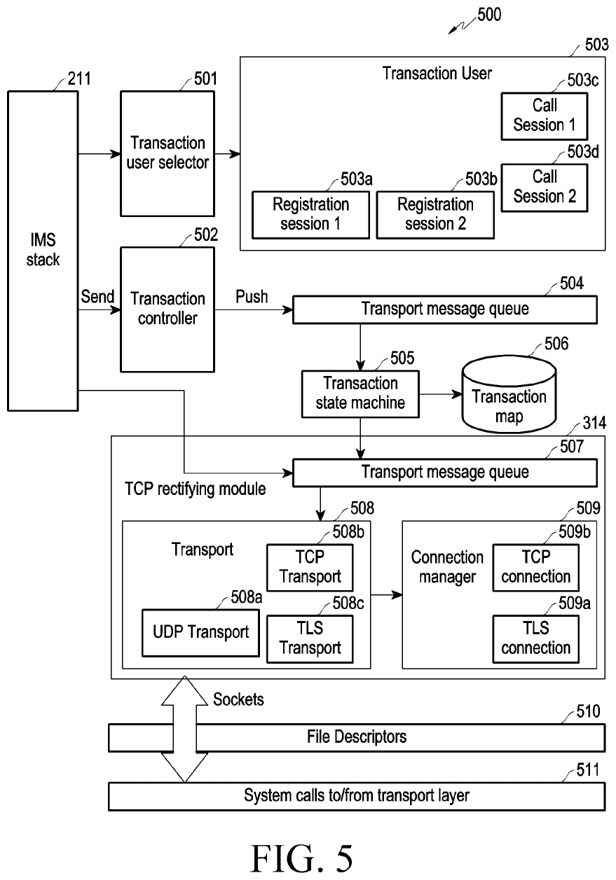

Referring now to FIG. 5, a functional block diagram of the TCP rectifying module (500) is illustrated, in accordance with an example embodiment. In an embodiment, the SIP is a layered protocol that allows different modules within it to function independently with just a loose coupling between each layer. The first (bottommost) layer in the protocol is the syntax and encoding layer. The second layer is the transport layer (511). This is the layer that dictates how clients/users send requests and receive responses and how servers receive requests and send responses. The transport layer (511) is closely related to the sockets layer of a SIP entity. The third layer is the transaction layer, wherein a transaction, in SIP terms, is a request that is sent by a client to a server, along with all responses to that request sent from the server back to the client. The transaction layer handles the matching of responses to requests. Application-layer re-transmissions and application-layer transaction timeouts are also handled in this layer and are dependent on the transport protocol used. A Transaction User (TU) (503) sends requests and receives responses, while a server transaction receives requests and sends responses. The transaction layer uses the transport layer for sending and receiving requests and responses. The fourth (topmost) layer is the Transaction User (TU) layer, wherein the TU layer creates client and server transactions. When a TU (503) wishes to send a SIP request it creates a client/user transaction instance and sends the request along with the destination IP address, port and name of the transport protocol to use. TUs (503) are defined to be User Agent Client (UAC) core and User Agent Server (UAS) core. UACs create and send requests and receive responses using the transaction layer, while UASs receive requests and create and send responses using the transaction layer.

In an embodiment, the IMS TCP rectifying module (314) act as an interface between the transaction layer and the transaction user layer. The appropriate transaction user (503) is chosen by a transaction user selector (501) based on the transaction ID, and the transaction message is added to a transport message queue (504) by a transaction controller (502). The transaction state machine (505) processes the message requests from the transport message queue (504) and adds messages to be sent to the network to the transport message queue (507) within the TCP rectifying module (314). For example, a call request or a registration request. More particularly, all the message to be sent to the network are added to the transport message queue (507). For e.g., IMS stack layer may add the request to delete the stale TCP connection into the transport message queue (507). Further, the transport selector selects the transport and connection from connection manager and process the socket scheduling to the transport layer (511). The transport layer (511) maintains an association between a socket and transport layer (511) addressing with the help of file descriptors (510). For e.g., it needs to identify the socket that corresponds to a particular <address, port> tuple for incoming data and generate TCP headers with appropriate addresses and port numbers for outbound packets. Furthermore, when any Socket is ready for WRITE/READ or when some exception is there, then the RIL (407) notifies to the TCP rectifying module (314).

The IMS interface (204), the IMS stack (211), the network monitoring module (202) and the transport rectifying module (314) may be implemented in an electronic device (e.g. a server, or an IMS server) through at least one processor of the electronic device.

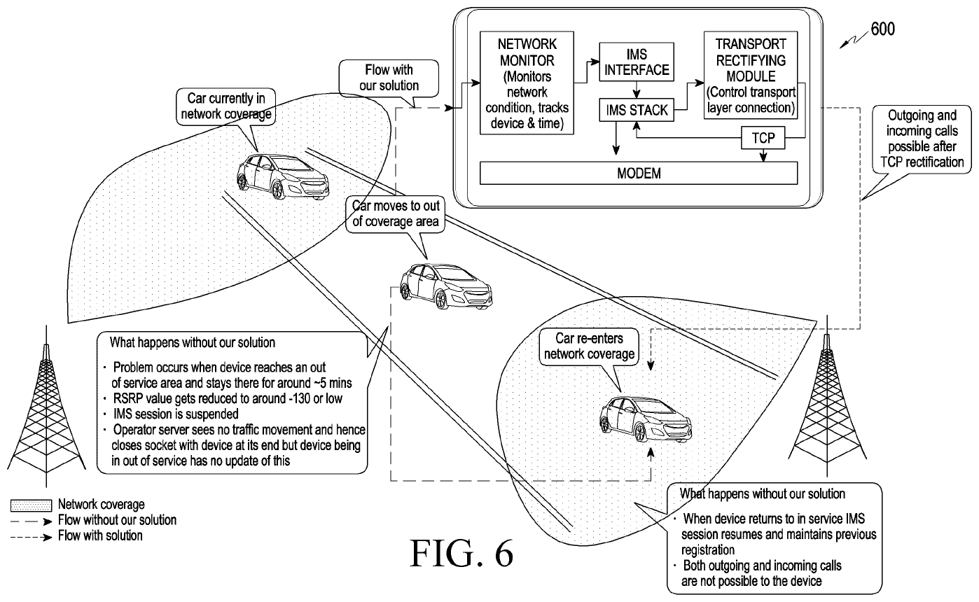

Referring now to FIG. 6, a snapshot of a first example configuration for auto recovery of the lost TCP connection is illustrated, in accordance with an example embodiment. When a user is travelling and enters an out of service region and remains there for approximately 5 minutes while on an IMS call, if the call is lost due to any reason, and the user then exits the out of service region. The issue arises as the process device suspends or terminates the IMS session until it remains in ‘out of service’ region and when the RSRP value falls below −130 dBm, the operator server detects no traffic movement and thus closes the socket with the device at its end, but the device is ‘out of service’ and receives no update on this. So, when the device returns to ‘in service’, the IMS session resumes and maintains previous registration, further both outgoing and incoming calls are not possible to the device. Therefore, sometimes the user needs to perform some functions such as turning on and turning off Airplane Mode or resetting the device that results in the reestablishment of the physical connection for continuing TCP session up for IMS communication, however, both outgoing and incoming calls are still not possible on the device. Certain example embodiments provide the monitoring of the network condition and tracking of the device and time with the help of network monitoring module. Further, it notifies the same to the IMS interface (204) which further verifies the monitored value and dispatches the IMS command to delete the stale TCP connection if TCP resetting is required. Subsequently, the IMS session is resumed and, outgoing and incoming calls are possible to the device.

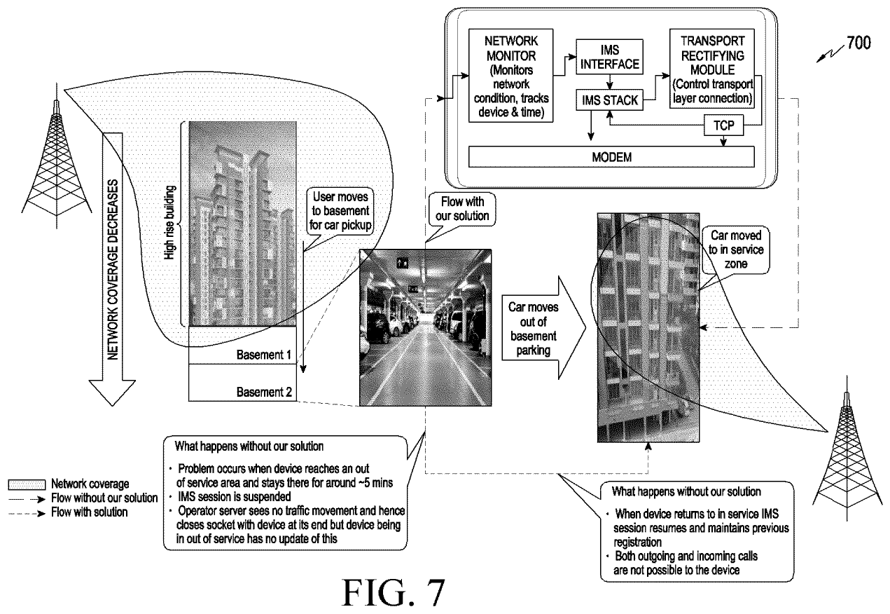

Referring now to FIG. 7, a snapshot of the second example configuration for auto recovery of the lost TCP connection is illustrated, in accordance with an example embodiment. The example illustrates a scenario when a user using a device moves to the basement to pick up the car and reaches an ‘out of service’ area and remains there for approximately 5 minutes. The IMS session is suspended, and the operator server sees no traffic movement and thus closes the socket with the device at its end, but the device being ‘out of service’ has no update of this. So now when the device returns to ‘in service’, the IMS session resumes and maintains previous registration, further both outgoing and incoming calls are not possible to the device. Certain example embodiments provide the monitoring of the network condition and tracking of the device and time with the help of network monitoring module. Further, it notifies the same to the IMS interface (204) which further verifies the monitored value and dispatches the IMS command to delete the stale TCP connection if TCP resetting is required. Subsequently, the IMS session is resumed, and outgoing and incoming call are possible to the device.

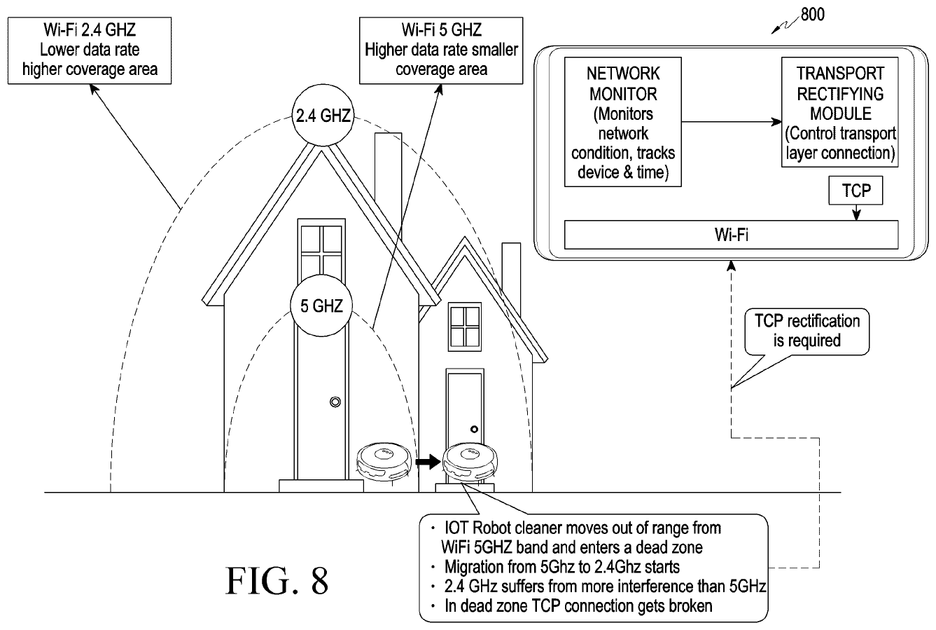

Referring now to FIG. 8, a snapshot of the third example configuration for auto recovery of the lost TCP connection is illustrated, in accordance with an example embodiment. In a smart home with multiple IoT devices, having such a situation where an IoT device physical connection is present, but the TCP connection is suspended, in other words there is a communication loss and restarting or resetting or self-diagnosis is required that led to suspension of physical connection first and then TCP connection reestablishment. (For example, smart robot cleaners, key rings, speakers, kids IoT toys, game controllers, and IoT controllers do not have fixed positions and are constantly changing in nature.) The issue arises when the IOT Robot cleaner moves out of WIFI 5 GHZ band range and enters a dead zone. The transition from 5 GHz to 2.4 GHz begins because 2.4 GHz suffers from more interference than 5 GHz. TCP connection is broken in the dead zone. Certain example embodiments provide the monitoring of the network condition and tracking of the device and time with the help of network monitoring module. Further, it notifies the same to the IMS interface (204) which further verifies the monitored value and dispatches the IMS command to delete the stale TCP connection if TCP resetting is required. Subsequently, the IMS session is resumed, and outgoing and incoming calls are possible to the device.

Each embodiment herein may be used in combination with any other embodiment(s) described herein. “Based on” as used herein covered based at least on.

Certain example embodiments provide a method to improve the stability of the TCP connection, less connectivity issues and minimum obstacles standing in the way of clear communication. Additionally, Certain example embodiments offers high customer satisfaction and reduced voice over customers.

While at least one exemplary embodiment has been presented in the foregoing detailed description, it should be appreciated that a vast number of variations exist.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for managing a connection by a server, the method comprising:
monitoring a state of a Transmission Control Protocol (TCP) connection for a communication session of a receiver device by Internet Protocol Multimedia Subsystem (IMS) stack, based on a plurality of signal parameters and connection context information for a defined period in absence of packet communication;
based on the state of the TCP connection for the communication session being suspended, closing the TCP connection; and
based on the state of the TCP connection for the communication session being registered, selecting one or more Session Initiation Protocol (SIP) timers for resetting and routing the communication session of the receiver device.

2. The method of claim 1, wherein the plurality of signal parameters and the connection context information are monitored by a network monitoring module comprising circuitry.

3. The method of claim 1, wherein the plurality of signal parameters comprises at least one of a Reference Signal Received Power (RSRP), a Reference Signal Received Quality (RSRQ), a Received Signal Strength Indicator (RSSI), a Signal to Interference Noise Ratio (SINR) or a Channel Quality Indicator (CQI).

4. The method of claim 1, wherein the monitored state of the TCP connection is notified to an IMS interface for resetting the TCP connection.

5. The method of claim 1, wherein the connection context information comprises a time spent by the receiver device at low signal strength, and a time point when the TCP connection is released.

6. The method of claim 1, wherein based on the state of the TCP connection for the communication session being suspended, stale TCP connections are removed by a transport rectifying module comprising circuitry, and the communication session is recovered by resetting the TCP connection.

7. The method of claim 1, wherein based on the state of the TCP connection for the communication session being suspended, stale TCP connections are removed by a transport rectifying module comprising circuitry, upon receiving a request to delete the stale TCP connection from an IMS interface.

8. The method of claim 1, wherein based on the state of the TCP connection for the communication session being registered, the communication session of the receiver device is resumed and redirected to a Communication Processor (CP) protocol layer based on a type of underlying physical transport information.

9. The method of claim 1, wherein the communication Session Initiation Protocol (SIP) is routed by a user agent.

10. The method of claim 1, wherein based on the monitored state of the TCP connection, a request to delete a stale TCP connection associated with a suspended session state of the receiver device is dispatched from an IMS interface to a request router, which forwards the request to a security transport interface.

11. The method of claim 1, wherein information about the one or more SIP timers is used by an IMS interface to trigger a transport rectifying module for removing a stale TCP connection.

12. The method of claim 1, wherein based on the state of the TCP connection for the communication session being suspended, a security transport interface acts as an interface between the IMS stack and a transport rectifying module.

13. The method of claim 1, wherein the plurality of signal parameters are tracked by at least one hardware device from a sensor, and notified to a Radio Interface Layer (RIL).

14. The method of claim 13, wherein for resetting the TCP connection, the Radio Interface Layer (RIL) acts as an abstraction layer between an IMS interface and at least one hardware device.

15. The method of claim 1, further comprising:
receiving IMS registration information of the receiver device; and
registering, in an IMS server, the receiver device at least by using the received IMS registration information of the receiver device.

16. The method of claim 1, wherein the IMS Stack generates a handling ID for each user agent and returns the generated handling ID to a connectivity framework for further communication with an IMS interface via Stack If.

17. A server for managing a connection, the server comprising:
communication circuitry;
at least one processor coupled to the communication circuitry, wherein the at least one processor is configured to:
monitor a state of a Transmission Control Protocol (TCP) connection for a communication session of a receiver device by Internet Protocol Multimedia Subsystem (IMS) stack, based on a plurality of signal parameters and connection context information for a defined period in absence of packet communication;
based on the state of the TCP connection for the communication session being suspended, close the TCP connection; and
based on the state of the TCP connection for the communication session being registered, select one or more Session Initiation Protocol (SIP) timers for resetting and routing the communication session of the receiver device.

18. The server of claim 17, wherein the plurality of signal parameters comprises at least one of a Reference Signal Received Power (RSRP), a Reference Signal Received Quality (RSRQ), a Received Signal Strength Indicator (RSSI), a Signal to Interference Noise Ratio (SINR) or a Channel Quality Indicator (CQI).

19. The server of claim 17, wherein the connection context information comprises a time spent by the receiver device at low signal strength, and a time point when the TCP connection is released.

20. The server of claim 17, wherein based on the state of the TCP connection for the communication session being suspended, the communication session is recovered by resetting the TCP connection.
